(19) United States
(12) Patent Application Publication
(10) Pub. No.: US 2023/0195722 A1
(43) Pub. Date: Jun. 22, 2023

(54) BLOCKCHAIN MANAGER SYSTEM

(71) Applicant: OMNIBEK IP HOLDING LLC, Holmdel, NJ (US)

(72) Inventor: Sergey Bekiyants, Holmdel, NJ (US)

(21) Appl. No.: 18/069,814

(22) Filed: Dec. 21, 2022

Related U.S. Application Data
(60) Provisional application No. 63/292,366, filed on Dec. 21, 2021.

(51) Int. Cl. G06F 16/23

(52) U.S. Cl. CPC G06F 16/2379

(57) ABSTRACT

Provided are systems and methods for updating a blockchain shared by a blockchain consortium, which can include a processor performing operations comprising receiving, from a follower organization and at a leader organization, a request to update a blockchain configuration. The leader organization is configured to update the blockchain configuration based on the request from the follower organization. The leader organization and the follower organization are included in the blockchain consortium. The operations may further comprise updating the blockchain configuration based on the request from the follower organization. The operations further comprise recording a system action to the blockchain, the system action representative of the updated blockchain configuration.

### CROSS-REFERENCE TO APPLICATIONS

This application claims priority to U.S. Provisional Application No. 63/292,366 entitled “BLOCKCHAIN MANAGER SYSTEM” and filed on Dec. 21, 2021, the disclosure of which is incorporated herein by reference in its entirety.

### TECHNICAL FIELD

The present disclosure relates generally to computer technology, and more particularly, to a blockchain manager system.

### BACKGROUND

A blockchain is a growing list of records or data blocks, which are linked together using cryptography to form a blockchain. A blockchain is typically managed by a peer-to-peer computing network in which the nodes in the network collectively adhere to a protocol for inter-node communication and validating new blocks. Once recorded, the data in any given block cannot be altered retroactively. As such, a blockchain may be used to produce an immutable record or ledger for the data recorded in each block in the blockchain.

Additionally, a blockchain may be used for “smart contracts” which are computer-executable agreements between two or more parties. Smart contracts may be tied to information on the blockchain that is configured to execute for performing a specified action in response to satisfying a specific condition. The execution of a smart contract is enforceable regardless of a desire to breach the contract by one of the parties. But permissioned distributed blockchains are always difficult to configure and support. As such, there is a need for computing infrastructures to manage a blockchain system shared by multiple organizations.

### SUMMARY

The present disclosure relates generally to the field of computer technology, including systems and methods useful for a blockchain manager system that are configured to update a blockchain shared by a blockchain consortium.

In one aspect, disclosed herein are methods for updating a blockchain shared by a blockchain consortium. The method includes receiving, from a follower organization and by one or more processors at a leader organization, a request to update a blockchain configuration. The leader organization is configured to update the blockchain configuration based on the request from the follower organization. The leader organization and the follower organization are included in the blockchain consortium. The method also includes updating, by the one or more processors, the blockchain configuration based on the request from the follower organization. The method also includes recording, by the one or more processors, a system action to the blockchain. The system action is representative of the updated blockchain configuration.

In some variations, updating the blockchain configuration includes at least one of adding an organization to the blockchain consortium, managing a smart contract, and deploying a new smart contract. Additionally, The follower organization includes a blockchain management service configured to send the request to the leader organization for updating the block configuration and where the request from the follower organization is received through an API call at the leader organization. Further, the method includes requesting, by the one or more processors, approval of the request to update the blockchain configuration from an additional organization in the blockchain consortium; receiving, by the one or more processors, the approval to update the blockchain configuration from the additional organization of the blockchain consortium; and updating, in response to receiving the approval to update the blockchain configuration from the additional organization and by the one or more processors, the blockchain configuration based on the request from the follower organization.

In some variations, the method includes sending, by the one or more processors, a response to the follower organization based on data obtained from a database, the data configured to enable the follower organization to record the system action to the blockchain based on the updated blockchain configuration. Further, the method includes notifying, by the one or more processors, the follower organization of the updated blockchain configuration; and instructing, by the one or more processors, the follower organization to record the system action to the blockchain, the system action representative of the updated blockchain configuration. Additionally, The leader organization is configured to perform at least one of adding an organization to the blockchain consortium, manage a smart contract, and validate the request to update the blockchain configuration from the blockchain consortium.

In some variations, the request to update the blockchain includes deploying a new smart contract and where the leader organization is configured to deploy the new smart contract based on the request from the follower organization. In some variations, the request to update the blockchain includes adding an organization to the blockchain consortium and where the leader organization is configured to obtain organization data from a database of the organization and records an act of adding the organization to the blockchain based on the request from the follower organization. In some variations, the request to update the blockchain configuration includes utilizing a blockchain manager service, the blockchain manager service including at least one of a monitoring service, a database adapter, and a secure storage adapter.

In another aspect, disclosed herein are systems for updating a blockchain shared by a blockchain consortium. The system includes at least one processor. The system also includes at least one non-transitory storage media storing instructions that, when executed by the at least one processor, cause the at least one processor to perform operations that receive, from a follower organization and at a leader organization, a request to update a blockchain configuration. The leader organization is configured to update the blockchain configuration based on the request from the follower organization. The leader organization and the follower organization are included in the blockchain consortium. The operations further update the blockchain configuration based on the request from the follower organization. The operations further record a system action to the blockchain, the system action representative of the updated blockchain configuration.

In some variations, the operations include updating the blockchain configuration includes at least one of adding an organization to the blockchain consortium, managing a smart contract, and deploying a new smart contract. The follower organization includes a blockchain management service configured to send the request to the leader organization for updating the block configuration and where the request from the follower organization is received through an api call at the leader organization. Further, the operations include: requesting approval of the request to update the blockchain configuration from an additional organization in the blockchain consortium; receiving the approval to update the blockchain configuration from the additional organization of the blockchain consortium; and updating, in response to receiving the approval to update the blockchain configuration from the additional organization, the blockchain configuration based on the request from the follower organization.

In some variations, the operations include: sending a response to the follower organization based on data obtained from a database, the data configured to enable the follower organization to record the system action to the blockchain based on the updated blockchain configuration. Additionally, the system may include: notifying the follower organization of the updated blockchain configuration; and instructing the follower organization to record the system action to the blockchain, the system action representative of the updated blockchain configuration. Further, the leader organization is configured to perform at least one of adding an organization to the blockchain consortium, manage a smart contract, and validate the request to update the blockchain configuration from the blockchain consortium. Additionally, the request to update the blockchain includes deploying a new smart contract and where the leader organization is configured to deploy the new smart contract based on the request from the follower organization.

In some variations, the request to update the blockchain includes adding an organization to the blockchain consortium and where the leader organization is configured to obtain organization data from a database of the organization and records an act of adding the organization to the blockchain based on the request from the follower organization.

In another aspect, disclosed herein are non-transitory computer-readable storage mediums for updating a blockchain shared by a blockchain consortium may include at least one program for execution by one or more processors of a first device. The non-transitory computer-readable storage medium performs operations including receiving, from a follower organization and by the one or more processors at a leader organization, a request to update a blockchain configuration. The leader organization is configured to update the blockchain configuration based on the request from the follower organization. The leader organization and the follower organization are included in the blockchain consortium. The operations include updating, by the one or more processors, the blockchain configuration based on the request from the follower organization. The operations include recording, by the one or more processors, a system action to the blockchain. The system action is representative of the updated blockchain configuration.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations as provided below.

FIG. 1 is an example environment in which multiple organizations maintain a blockchain including a smart contract;

FIG. 2 is a diagram of one or more organizations interacting using a blockchain manager system configured to maintain the blockchain;

FIG. 3 is a block diagram of components in a blockchain manager service;

FIG. 4 is a block diagram of a core of a blockchain manager service;

FIG. 5 is a block diagram of a blockchain deployment tool;

FIG. 6 is a flowchart of an implementation of the blockchain deployment tool configured to deploy and upgrade a blockchain;

FIG. 7 is a flowchart of an implementation of the blockchain manager service registering a new organization in a blockchain consortium;

FIG. 8 is a flowchart of an implementation of the blockchain manager service configured to create and update a blockchain consortium;

FIG. 9 is a flowchart of an implementation of the blockchain manager service configured to create and update a ledger or smart contract;

FIG. 10 is a flowchart of an implementation of the blockchain manager service of a leader organization configured to confirm an action by a follower organization;

FIG. 11 is a flowchart of an implementation of the blockchain manager service configured to release a new version of a smart contract;

FIG. 12 is a flowchart of an implementation of the blockchain manager service configured to obtain a connection profile;

FIG. 13 is a flowchart illustrating an example of an updating process for a blockchain manager system, in accordance with some example embodiments; and

FIG. 14 is a block diagram illustrating a computing system, in accordance with some example embodiments.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In some aspects and/or embodiments, systems, methods, and computer program products described herein include and/or implement a blockchain manager system for managing a plurality of organizations that maintain a blockchain. The blockchain manager system may be configured to create, manage, and administer permissioned distributed ledgers. The permissioned distributed ledgers may be maintained and operate on behalf of a set of identified participants or organizations. Organizations may be identified by their certificate authorities that enable the organizations to perform permissioned actions on the blockchain. Additionally, organizations may be denied from preventing certain actions. For example, a follower organization may not have the authority to upgrade to a new version of a smart contract. In some cases, organizations may act with authority for other organizations as the agent organization has additional authority, technical capability, or interconnectedness to the consortium and the corresponding blockchain. For example, a leader organization may have the technical capability to update a smart contract that would otherwise be outside of the follower organization's capability.

Unlike other organizations that manage blockchains, the blockchain manager system described herein is configured to quickly and efficiently establish authenticating relationships among the various organizations via a scalable private blockchain and certificate authorities. The blockchain manager system averts messy deployment of private blockchains, streamlines the application development on private blockchains, and presents comprehensive tools for high scalability and security of the blockchain. Examples of blockchain security and streamlining of application development include easy ledger partitioning and support for mainstream open-source private blockchain technologies. With increased permission, leader organizations may perform these acts on behalf of follower organizations to increase the scalability and the security of the blockchain.

Further, the blockchain manager system solves technical problems associated with the scaling and security of a blockchain including smart contracts. For example, a leader organization may be configured to deploy and upgrade a ledger configuration that a follower organization does not otherwise have permission to perform. Other technical problems include messy implementations of adding organizations to the blockchain consortium, releasing new versions of the smart contract, and obtaining a connection profile. The blockchain manager system is configured to correct the shortcomings of other organizations running blockchain by implementing the unique architecture and procedural steps described herein.

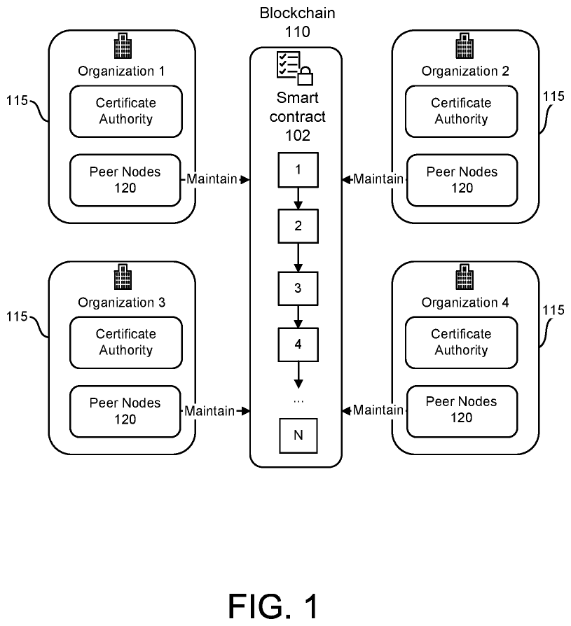

Referring now to FIG. 1, illustrated is example environment in which multiple organizations may maintain a blockchain 110 including a smart contract 102. The blockchain 110 may be a peer-to-peer network in which members of the network have access to a shared distributed ledger. A distributed ledger may be an immutable log of transactions grouped and cryptographically bound into a chain of blocks. Transactions may be approved actions connected to a smart contract 102 to change a distributed ledger state. In some embodiments, the transactions may be approved by consensus of the various organizations 115.

The smart contract 102 may be a software program running at each of the peer nodes 120 alongside the blockchain 110. An organization 115 may be a participant of a permissioned distributed blockchain and may represent a party to an agreement of a smart contract 102 on the blockchain 110. Together, the group of organizations participating in the authenticating architecture may be a consortium. Each organization 115 may run one or more peer nodes 120. The peer nodes 120 may run smart contracts, accept new transactions, validate new transactions, and store a local copy of ledgers. The organizations 115 may form a consortium.

Organizations 115 may be identified by certificate authorities 230. The blockchain manager system 205 for each organization 115 may be configured to apply comprehensive tools for the creation, management, and administration of permissioned distributed ledgers and certificate authorities 230. The organization 115 may be configured to maintain and operate the permissioned distributed ledger on behalf of a set of identified participants or organizations 115 according to their certificate authority 230. Organizations 115 may have members a peer, a client, and an administrator. Organizations 115 may have a leader status or a follower status within the consortium. The identity of the organization 115 may be registered by a certificate authority 230. For example, an organization 115 may have a leader status and may be configured to perform more tasks and activities for an organization 115 having a follower status. These tasks and activities include deploying a new smart contract and upgrading a ledger configuration. In another example, an organization 115 having a leader status may update a smart contract for an organization having a follower status.

The blockchain manager system 205 for each organization 115 may be configured to enable organizations to quickly and efficiently establish authenticating relationships with each other via a scalable private blockchain and certificate authorities 230. The blockchain manager system 205 may be configured to carry out a clean deployment of private blockchain 110. Additionally, each blockchain manager system 205 may be configured to streamline the application development based on private blockchain 110. Each blockchain manager system 205 may be configured to implement high scalability and security of the blockchain 110. For example, the blockchain manager system 205 may be configured to implement ledger partitioning and support for mainstream open-source private blockchain technologies.

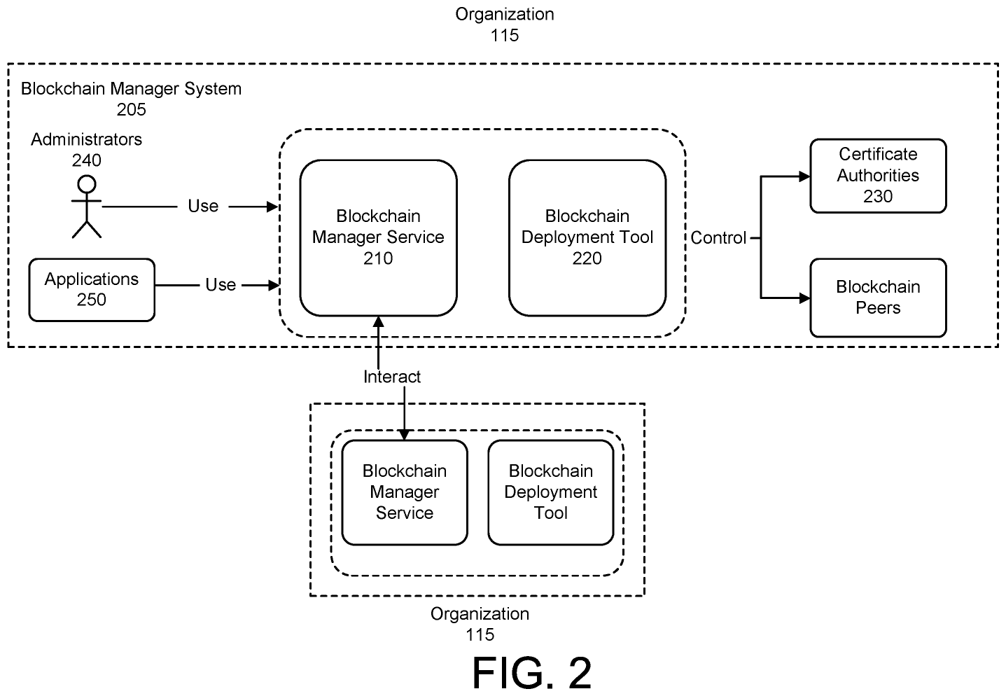

Referring now to FIG. 2, one or more organizations 115 may interact using its corresponding blockchain manager system 205. An organization 115 may include a blockchain manager system 205 that is configured to receive instructions from administrators 240 and applications 250. Further, the blockchain manager system 205 may be configured to send instructions to follower organizations and perform blockchain activities. The blockchain manager system 205 may include two services: the blockchain manager service 210 and the blockchain deployment tool 220. The blockchain manager system 205 may be a mid-layer software between blockchain and blockchain administrators and may be configured to interact with organizations or entities having a blockchain manager system 205. The blockchain manager system 205 may have an application programming interface (API) configured to make API calls to other blockchain manager systems 205 of other organizations in the consortium.

Organizations 115 may form an enterprise blockchain maintained by the various blockchain manager systems 205. An organization 115 may include a blockchain manager system 205 configured to control certificate authorities 230 and blockchain peers. Administrators 240 at the organization 115 and corresponding applications 250 may utilize the blockchain manager systems 205 to perform various permissioned tasks, such as deploying a new version of a smart contract 102. Such organizations may be follower organizations that rely on leader organizations to perform tasks. For example, organization B may rely on organization A to perform an upgrade of the blockchain version on its behalf. In another example, organization B may rely on organization A to deploy a new smart contract. In some embodiments, each organization 115 is required to run its own peer nodes 120, certificate authorities 230, and blockchain manager system software. The number of organizations may be unrestricted.

Each organization 115 may have a certificate authority 230. The certificate authority 230 may be indicative of the activities that the organization 115 has permission to perform on the blockchain 110. The certificate authority 230 may be indicative of which organizations 115 have the controlling decision in performing an activity to the blockchain 110. In some embodiments, the certificate authority 230 may be a root certificate authority or an intermediate certificate authority. A root certificate may be a public key certificate that identifies a root certificate authority. Root certificates may be self-signed and may include the top-most certificate in an authorization tree. An intermediate certificate or subordinate certificate authority certificate may be signed by the root certificate and inherit the trustworthiness of the root certificate.

Each organization 115 may include a peer node 120. The peer node 120 may be an interface through which the organization 115 communicates with other organizations. Similarly, other organizations communicate with the organization via the peer node 120. The peer nodes 120 of the organizations may form the blockchain 110 and at least one peer node 120 for each organization 115 is required to participate in the blockchain 110.

An administrator 240 may represent the organization 115 and use the blockchain manager system 205 on behalf of the organization 115. The administrator 240 may upgrade and maintain the blockchain 110, monitor the blockchain health, and issue new blockchain identities via the blockchain manager system 205. An application 250 of an organization 115 may be integrated with the blockchain manager system 205. The application 250 may listen to blockchain events, derive authenticating events from blockchain events, perform service discovery, and monitor the blockchain 110 via the blockchain manager system 205. Service discovery may include identifying other peer nodes 120 and organizations 115 on the blockchain 110. A blockchain event may include upgrading the blockchain 110, the registration of a new organization, updating the consortium, updating a ledger or smart contract 102, releasing a new version of a smart contract 102, or obtaining a connection profile. A connection profile may be a set of key-value pairs required to establish a connection with the blockchain 110, such as a peer address or a smart contract name.

The blockchain deployment tool 220 may be configured to deploy private blockchains and permissioned distributed ledgers between authenticating entities. The blockchain deployment tool 220 may be configured to reduce operational overhead for configuring and deploying private blockchains. The blockchain deployment tool 220 may be configured to enable upgrades of existing private blockchain across the authenticating architecture with new authenticating organizations. In some embodiments, the blockchain deployment tool 220 may be highly modular and may be configured to provide support for different types of crypto storages required to secure private keys and certificates. The blockchain deployment tool 220 may be configured to deploy and upgrade configurations for new and existing blockchain organizations. Configurations for new blockchains may include deployment of certificate authorities 230, peer organization provisioning, and the creation of identities. Configurations for existing blockchains may include deployment of intermediate certificate authorities 230 and adding, upgrading, and deleting peer nodes 120 with zero downtime.

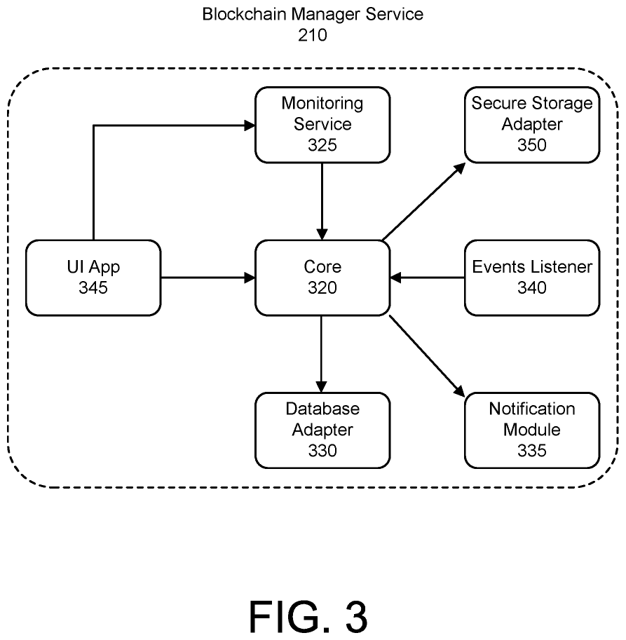

Referring now to FIG. 3, illustrated is a block diagram of components in a blockchain manager service 210. As illustrated, the blockchain manager service 210 includes a core 320, a monitoring service 325, a database adapter 330, a notification module 335, an events listener 340, a user interface application 345, and a secure storage adapter 350. The blockchain manager service 210 may be included in the blockchain manager system 205. The blockchain manager service 210 may be configured to interact with organizations 115 or entities having a blockchain manager system 205. The blockchain manager service 210 may be a mid-layer software between blockchain and blockchain administrators. The blockchain manager service 210 may have an application programming interface (API) configured to interact with administrators, applications, and other blockchain manager systems 205 of other organizations. The blockchain manager service 210 may be configured to provide an environment for cooperation and interaction between organizations 115 of blockchain consortium. For example, the blockchain manager service 210 may be configured to enable the creation of proposals for a vote among network members or enable signature collection.

The blockchain manager service 210 may be configured to launch in one of two modes: a lead mode and a follow mode. Organizations 115 with a blockchain manager service 210 in a lead mode may be a leader organization and organizations with a blockchain manager service 210 in a follow mode may be a follower organization. A leader organization may perform tasks for a follower organization. For example, a leader organization may update a smart contract on behalf of a follower organization. Additionally, the leader organization may be configured to initialize updates of blockchain configurations for itself and on behalf of follower organizations. For example, the leader organization may add a new organization to the consortium, create a new ledger, install a new smart contract, and deploy a new version of a smart contract for itself and on behalf of a follower organization.

The blockchain manager service 210 may have a monitoring service 325. The monitoring service 325 may be configured to monitor certificate authority servers, peer nodes 120, and blockchain ledgers. The monitoring service 325 may be configured to track operational metrics related to requests, computational loads, memory usage, and data storage. The monitoring service 325 may be communicatively coupled to the core 320 and may be configured to monitor different parts of the blockchain 110 and expose data for analytics. The monitoring service 325 may be communicatively coupled to the user interface application 345 and may be configured to receive instructions from regulate events at the blockchain. The monitoring service 325 may be communicatively coupled to the events listener 340 and the notification module 335 to detect blockchain activity and to instruct the notification module 335 to generate notifications based on the blockchain activity. In some embodiments, the monitoring service 325 may include a metrics collector configured to collect metrics from the blockchain using push and pull approaches. For example, the monitoring service 325 may be configured to pull metrics on a scheduled basis. In another example, the monitoring service 325 may be configured to receive pushed notifications containing metrics. The monitoring service 325 may include a metrics storage configured to store the collected metrics from the metrics collector. The monitoring service 325 may include an application programming interface configured to receive API calls that request data analytics gathered by the metrics collector and stored by the metrics storage.

The blockchain manager service 210 may be configured to manage the dynamic membership of organizations 115 in the consortium. For example, the blockchain manager service 210 may be configured to support the addition and removal of organizations 115. In another example, the blockchain manager service 210 may be configured to add or remove peer nodes 120 at a blockchain network. In some embodiments, the blockchain manager service 210 may be configured to administer certificate authority 230 root and intermediate servers. The blockchain manager service 210 may be configured to manage smart contracts to provide control of smart contract lifecycle. For example, the uploading, validating, signing, installing, instantiating, and upgrading may be performed by the blockchain manager system 205.

The blockchain manager system 205 may include a secure storage adapter 350. The secure storage adapter 350 may be configured to manage the private keys and certificates of various blockchain entities. For example, the secure storage adapter 350 may be configured to securely store and retrieve private keys and certificates of new and existing blockchain entities.

The blockchain manager system 205 may include an events listener 340. Service discovery may include providing information on how to interact on the blockchain. For example, service discovery may collect information on available peers, related ledgers, installed smart contracts, and certificate authorities 230 on the permissioned distributed ledger. The events listener 340 may be configured to collect information about blockchain events. The events listener 340 may be configured to stream blockchain events to message brokers. In some embodiments, the events listener 340 may be configured to subscribe to smart contract events via the blockchain API. In some embodiments, the events listener 340 may be configured to select events, transform events, and forward events to the message broker. The events listener 340 may include a message broker adapter configured to provide integration with different types of message brokers. For example, the message broker adapter may be configured to forward notifications to a message broker based on a subscription. In some embodiments, the message broker adapter may be configured to instruct the notification module 335 to generate notifications based on the blockchain activity.

The blockchain manager service 210 may include a database adapter 330. The database adapter 330 may be configured to store and retrieve information about all organizations involved in the blockchain 110. For example, the database adapter 330 may be configured to collect information on available peers, related ledgers, installed smart contracts, and certificate authorities 230. The blockchain manager service 210 may include a user interface to facilitate interaction. The user interface may provide blockchain software development kits (SDKs) and connection profiles to streamline blockchain development.

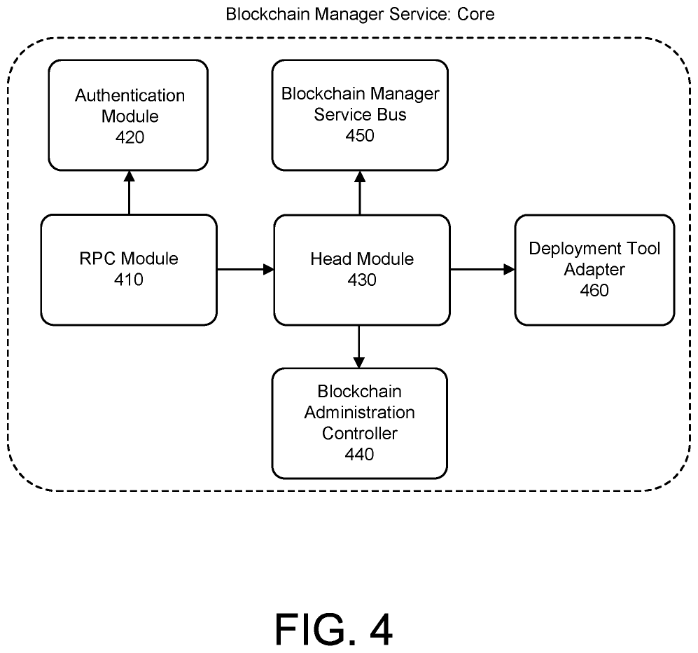

Referring now to FIG. 4, illustrated is a block diagram of a core 320 of a blockchain manager service 210. The core 320 may be configured to implement the main functionality of the blockchain manager service 210. The core 320 may include an RPC module 410, an authentication module 420, a head module 430, a blockchain administration controller 440, blockchain manager services bus 450, and a deployment tool adapter 460.

The head module 430 may be configured to handle incoming requests by leveraging and utilizing other components in the blockchain manager service 210. The head module 430 may include a controller communicatively coupled to the peer nodes 120, the consortium, the certificate authority 230, the ledger, and smart contracts. The head module 430 may be configured to handle the incoming requests from the consortium and peer nodes 120 via remote procedure call (RPC) requests. The head module 430 may be configured to manage ledgers of the blockchain 110, including the creating, sharing, and archiving of ledgers. The head module 430 may be configured to manage smart contract versions and be configured to control the initialization of smart contracts on ledgers.

The RPC module 410 may be configured to receive and handle requests for a service from a computer outside the network. The RPC module 410 may also be configured to receive API requests and forward an API request to the head module 430 as needed. The RPC module 410 may be configured to return requested information to the blockchain manager system 205 outside of the network. The authentication module 420 may provide authentication and authorization based on the Public Key Infrastructure (PKI) system. The PKI system includes processes, technologies, and policies that enable the encryption and signature of data.

The blockchain administration controller 440 may be a middleware controller between the head module 430 and the blockchain API. The blockchain administration controller 440 may be configured to implement basic abstraction for interaction with the blockchain and support various blockchain technologies. The blockchain manager services bus 450 may be a communication layer configured to transfer requests and data between the blockchain manager services 210 and other organizations 115. The deployment tool adapter 460 may be configured to enable the head module 430 to interact with blockchain deployment tool 220.

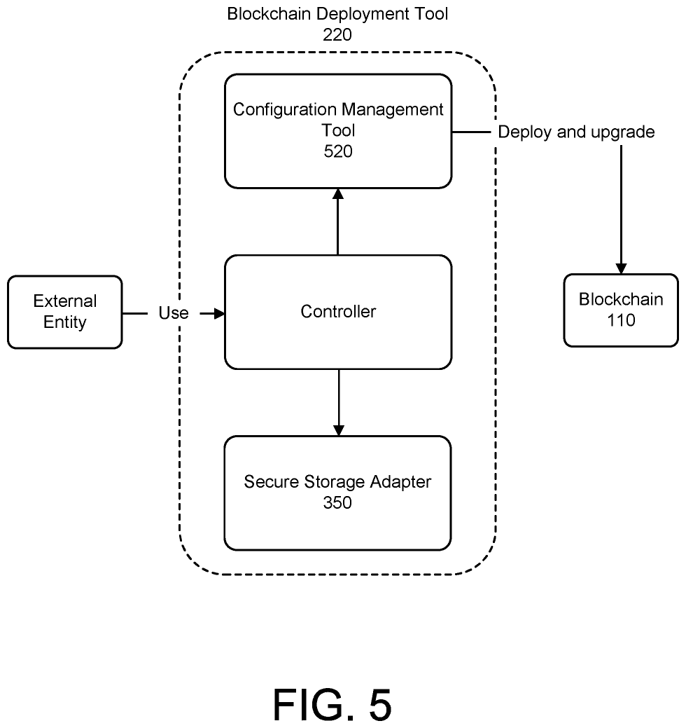

FIG. 5 shows a block diagram of a blockchain deployment tool 220. As illustrated, the blockchain deployment tool 220 may deploy private blockchains and permissioned distributed ledgers between authenticating entities. The blockchain deployment tool 220 may reduce operational overhead for configuring and deploying the private blockchains. The blockchain deployment tool 220 may be configured to enable upgrades of existing private blockchain with new authenticating organizations. In some embodiments, the blockchain deployment tool 220 may be highly modular and may be configured to support for different types of crypto storages required to secure private keys and certificates. The blockchain deployment tool 220 may be configured to deploy and upgrade configurations for new and existing blockchain organizations. Configurations for new blockchains may include deployment of certificate authorities 230, peer organization provisioning, and the creation of identities. Configurations for existing blockchains may include deployment of intermediate certificate authorities 230 and adding, upgrading, and deleting peer nodes 120 with zero downtime.

The blockchain deployment tool 220 may be configured to deploy development blockchain environments with low resource consumption and low complexity. The blockchain deployment tool 220 may be configured to test the setup but without the distribution of blockchain responsibilities among different parties. This feature may facilitate integration testing, load testing, and continuous integration practices. The blockchain deployment tool 220 may be configured to support different distributed ledger technologies to run the private blockchain network.

The blockchain deployment tool 220 may include a controller configured to handle API calls for external usage by administrators and the blockchain management service. The controller may utilize the configuration management tool 520 configured to deploy and upgrade blockchain peer nodes 120 and certificate authorities 230. The configuration management tool 520 may be configured to enable custom deployment via deployment instructions and configuration parameters as inputs. The blockchain deployment tool 220 may be configured to deploy and support different blockchain technologies.

The blockchain deployment tool 220 may include a secure storage adapter 350 configured to provide functionality for preserving blockchain private keys and certificates in a secure manner. The secure storage adapter 350 may be configured to manage the private keys and certificates of various blockchain entities. For example, the secure storage adapter 350 may be configured to securely store and retrieve private keys and certificates of new blockchain entities.

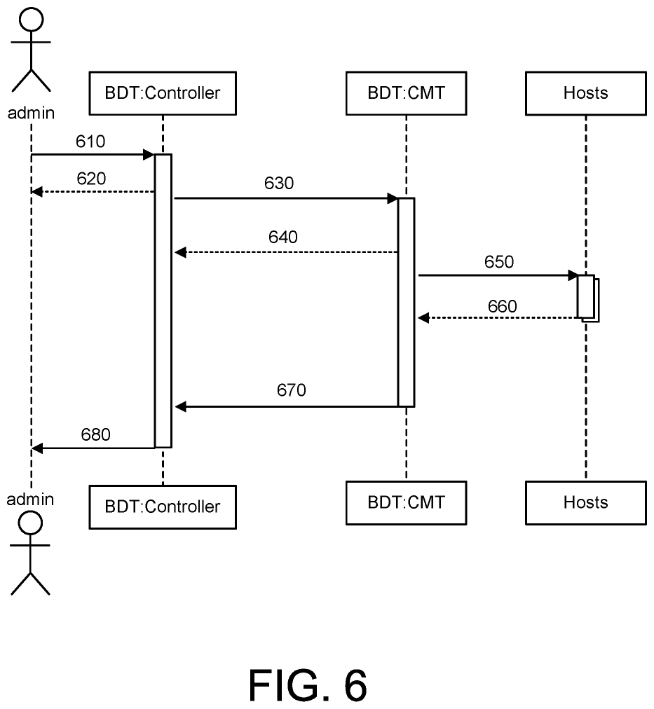

Referring now to FIG. 6, illustrated is a flowchart of an implementation of the blockchain deployment tool 220 configured to deploy and upgrade a blockchain 110. The configuration management tool 520 may be configured to upgrade and deploy via deployment instructions and custom configuration parameters. The blockchain deployment tool 220 may be integrated into the blockchain manager system 205 and may be configured to deploy and support different blockchain technologies.

At step 610, the blockchain manager system 205 may be configured to receive a prompt from an administrator to upgrade or deploy a blockchain 110 shared by the blockchain consortium. More specifically, a controller of the blockchain deployment tool 220 may be configured to receive a prompt from an administrator to upgrade or deploy a blockchain 110. For example, the controller may receive a configuration file from the administrator to start the blockchain deployment tool 220 with various parameters by invoking a run command at the controller. At step 620, the controller of the blockchain deployment tool 220 may be configured to confirm the prompt from the administrator to upgrade or deploy the blockchain. For example, the controller may confirm the configuration file with its various parameters and confirm the initialization of deployment or upgrading of the blockchain including the smart contract.

At step 630, the controller at the blockchain deployment tool 220 may be configured to operate the configuration management tool 520. The configuration management tool 520 may be configured to deploy and upgrade blockchain peer nodes 120 and certificate authorities 230 via the configuration file from the controller. The controller at the configuration management tool 520 may be configured to pass configuration variables to the configuration management tool 520. At step 640, the controller of the blockchain deployment tool 220 may be configured to receive a confirmation from the configuration management tool 520. For example, the configuration management tool 520 may confirm the passing of the configuration variables to the configuration management tool 520. In another example, the configuration management tool 520 may confirm the initialization of deployment or upgrading of the blockchain 110 including the smart contract 102.

At step 650, the configuration management tool 520 may be configured to initiate the upgrading or deployment of the blockchain 110. For example, the configuration management tool 520 may upgrade blockchain peer nodes 120 and certificate authorities 230 of the various hosts via the configuration file from the controller. At step 660, the configuration management tool 520 may be configured to confirm the completion of the upgrading or deployment of the blockchain 110 to the various hosts. At step 670, the configuration management tool 520 may be configured to notify the controller at the blockchain deployment tool 220 that the deploying and upgrading of the blockchain is complete. At step 680, the controller at the blockchain deployment tool 220 may be configured to notify the administrator that the deploying and upgrading of the blockchain 110 is complete. For example, the controller may output a pop-up window at a computer terminal to notify the administrator that the deploying and upgrading of the blockchain 110 is complete.

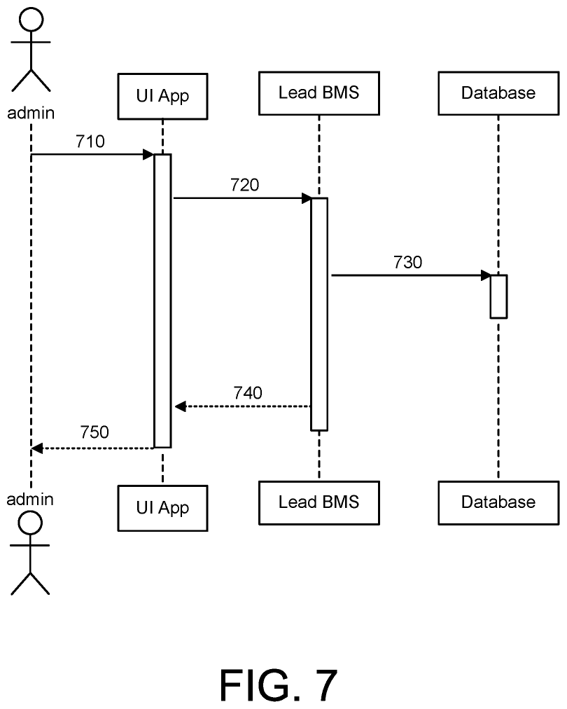

Referring now to FIG. 7, illustrated is a flowchart of an implementation of the blockchain manager service 210 registering a new organization in a blockchain consortium. The blockchain manager service 210 may be configured to interact with organizations 115 or entities having a blockchain manager system 205 and may be a mid-layer software between blockchain and blockchain administrators. The blockchain manager service 210 may have an application programming interface (API) configured to interact with administrators 240, applications 250, and other blockchain manager systems 205 of other organizations 115. The blockchain manager service 210 may be configured to provide an environment for cooperation and interaction between organizations of a blockchain consortium. For example, the blockchain manager service 210 may enable the registration of a new organization on the blockchain consortium. In some embodiments, a leader organization may deploy and upgrade a ledger on behalf of the consortium.

At step 710, the user interface application 345 may be configured to receive a registration request or an organization to be registered at the blockchain consortium from an administrator. For example, the user interface application 345 may be configured to receive parameters and a configuration setup for an organization for registration at the blockchain consortium. The administrator and the user interface application 345 may be at a follower organization. At step 720, the user interface application 345 may be configured to pass the request to the leader blockchain manager service. The leader blockchain manager service may be configured to update a configuration for the new organization on behalf of a follower organization.

At step 730, the leader blockchain manager service may be configured to validate the new organization data and retain the data in its database. For example, the leader blockchain manager service may validate the new organization data by adding a blockchain transaction to the permissioned distributed ledger. Additionally, the blockchain manager service 210 may be configured to store the new organization data via the database adapter 330. The database adapter 330 may be configured to store and retrieve information about all registered organizations added in the blockchain 110. The database adapter 330 may be configured to store data related to the registered organizations, such as organization information, ledger inputs, installed smart contracts, and certificate authorities 230. The leader blockchain manager service may include a user interface to facilitate interaction. The user interface may provide blockchain SDKs and connection profiles to streamline blockchain development.

At step 740, the leader blockchain manager service may be configured to send a confirmation of the validation of the new organization data added to the database. Additionally, the leader blockchain manager service may be configured to confirm that the new organization is registered and that the new organization data is stored in the database. For example, the leader blockchain manager service may be configured to send a confirmation to a follower organization that requested the registration of the new organization. At step 750, the leader blockchain manager service may be configured to notify the administrator that the registration of the new organization is complete. For example, the controller may output a pop-up window via the user interface application 345 to notify the administrator that the deploying and upgrading of the blockchain is complete. In some embodiments, a leader organization may deploy and upgrade a ledger on behalf of a consortium.

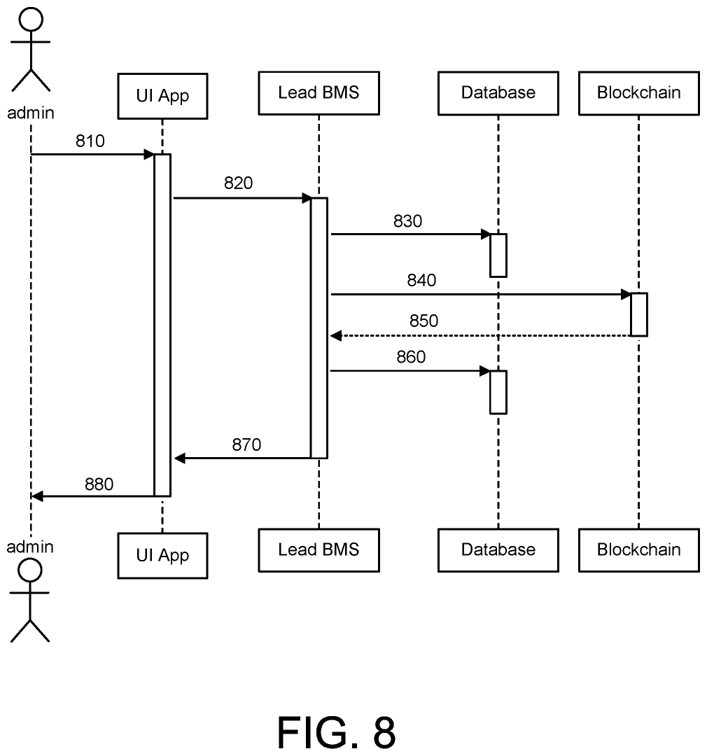

Referring now to FIG. 8, illustrated is a flowchart of an implementation of the blockchain manager service 210 configured to create and update a blockchain consortium. The blockchain manager service 210 may be configured to facilitate interaction between organizations of the blockchain consortium. Updating a blockchain consortium may include updating organizational hierarchy, updating a condition for a smart contract and updating a ledger configuration of the permissioned distributed ledger. In some embodiments, a leader organization may create and update a blockchain consortium on behalf of a consortium.

At step 810, the user interface application 345 may be configured to receive a request from an administrator to update the consortium. For example, the user interface application 345 may be configured to receive parameters and a configuration setup for the creation and updating of the blockchain consortium. The administrator and the user interface application 345 may be at a follower organization. At step 820, the user interface application 345 may be configured to pass the request to the leader blockchain manager service. For example, the user interface application 345 may make an RPC request or API call to the leader blockchain manager service within the current organization or at a different organization. The leader blockchain manager service receiving the RPC request may be configured to create and update a blockchain consortium on behalf of a follower organization.

At step 830, the leader blockchain manager service may be configured to retrieve organizational data from the database. Organization data may include information related to the registered organizations such as organization information, ledger inputs, installed smart contracts, and certificate authorities 230. The database may be configured to store and retrieve information about all registered organizations added in the blockchain. The leader blockchain manager service may be configured to retrieve the organizational data via the database adapter 330. The leader blockchain manager service may be configured to provide blockchain SDKs and connection profiles to streamline blockchain development.

At step 840, the leader blockchain manager service may be configured to prepare and execute a transaction to blockchain for updating the ledger configuration state. For example, the leader blockchain manager service may prepare an updated hierarchy structure of the consortium or rules for registering a new organization. The leader blockchain manager service may prepare a transaction to be added to the permissioned distributed ledger to be approved by the other organizations upon agreement to update the hierarchy structure of the consortium or the rules for registering the new organization.

At step 850, the leader blockchain manager service may be configured to validate the new organization data and retain the data in its database. For example, the leader blockchain manager service may be configured to store the updated ledger configuration state to the database. Additionally, the leader blockchain manager service may be configured to store the updated ledger configuration state via the database adapter 330. The database adapter 330 may be configured to store and provide information about all registered organizations added in the blockchain 110. The database adapter 330 may be configured to store data related to the registered organizations, such as organization information, ledger inputs, installed smart contracts, and certificate authorities 230.

At step 860, the leader blockchain manager service may be configured to send a confirmation of the validation of the updated ledger configuration state. For example, the leader blockchain manager service may be configured to send a confirmation to a follower organization of the updated ledger configuration state. At step 870, the leader blockchain manager service may notify the administrator that the updated ledger configuration state is complete. For example, the controller may output a pop-up window via the user interface application 345 to notify the administrator that the deployment and upgrading of the blockchain 110 is complete. In some embodiments, a leader organization may create or update a configuration on behalf of a follower organization. In some embodiments, a leader organization may be configured to update a ledger on behalf of a follower organization.

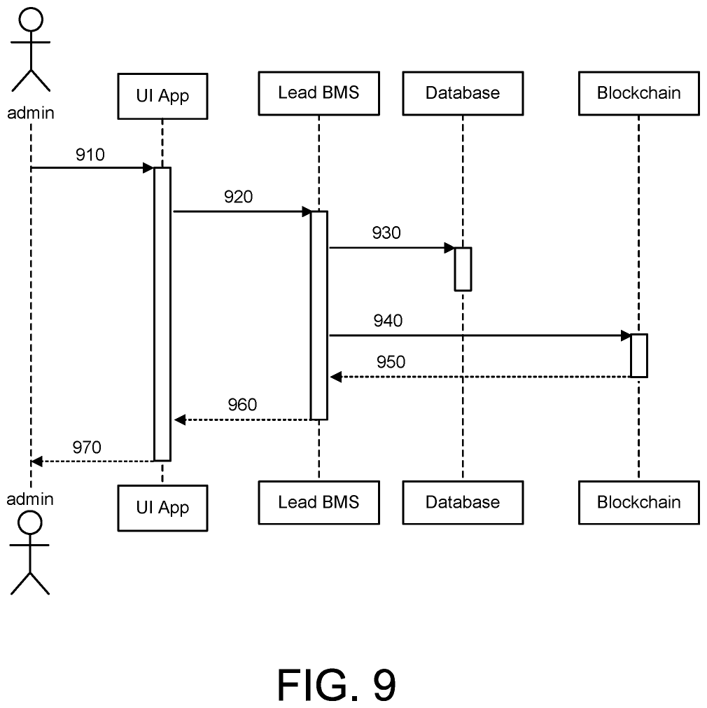

Referring now to FIG. 9, illustrated is a flowchart of an implementation of the blockchain manager service 210 configured to create and update a ledger or smart contract. A smart contract may be a software program running at each of the peer nodes 120 alongside the blockchain 110. An organization may be a participant of the permissioned distributed ledger and may represent a party to an agreement of a smart contract on the blockchain 110. Together, the group of organizations 115 sharing an authenticating relationship may be a consortium. Each organization 115 may run one or more peer nodes 120. The peer nodes 120 may run smart contracts, accept new transactions, validate new transactions, and store a local copy of ledgers. Together the organizations 115 may form a consortium.

At step 910, the user interface application 345 may be configured to receive a request from an administrator to create a ledger or smart contract. For example, the user interface application 345 may be configured to receive parameters and a configuration setup for creating and updating the ledger or smart contract. The administrator and the user interface application 345 may be at a follower organization. At step 920, the user interface application 345 may be configured to pass the request to the leader blockchain manager service. For example, the user interface application 345 may make an RPC request or API call to the leader blockchain manager service within the current organization or at a different organization. The leader blockchain manager service receiving the RPC request may be configured to create and update the ledger or smart contract on behalf of a follower organization.

At step 930, the leader blockchain manager service may be configured to store the created ledger or smart contract to the database. The leader blockchain manager service may store the ledger or smart contract via the database adapter 330. The database adapter 330 may be configured to store and provide information about all created ledgers and smart contracts added to the blockchain. The database adapter 330 may be configured to update the stored data related to the ledgers and smart contracts.

At step 940, the leader blockchain manager service may be configured to execute a transaction to the blockchain for creating a ledger or smart contract. For example, the leader blockchain manager service may prepare an updated smart contract or a new ledger documenting an agreement between the organizations of the consortium. The leader blockchain manager service may be configured to prepare a transaction to be added to the permissioned distributed ledger for approval by the other organizations upon agreement to smart contract of the consortium. At step 950, the leader blockchain manager service may be configured to receive a confirmation of the new smart contract or ledger being created at the blockchain 110.

At step 960, the leader blockchain manager service may be configured to send a confirmation of the creation the ledger or smart contract 102. For example, the leader blockchain manager service may be configured to send a confirmation to a follower organization of the newly created smart contract at the blockchain 110. At step 970, the leader blockchain manager service may be configured to notify the administrator that the creation of the smart contract 102 is complete. For example, the controller may output a pop-up window via the user interface application 345 to notify the administrator that the deploying and upgrading of the blockchain 110 is complete. In some embodiments, a leader organization may be configured to create or update the smart contract of a follower organization.

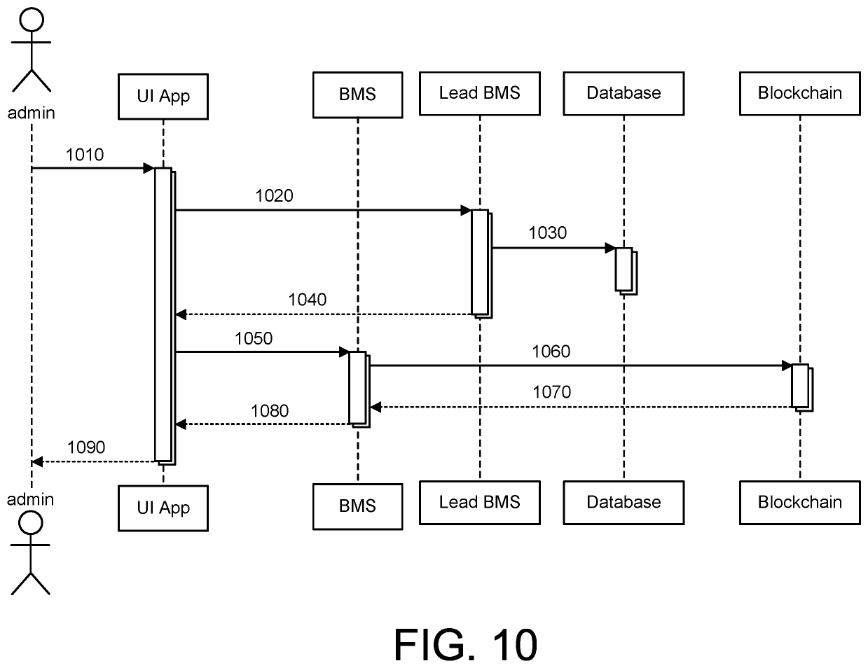

Referring now to FIG. 10, illustrated is a flowchart of an implementation of the blockchain manager service 210 of a leader organization configured to confirm an action by a follower organization. The identity of the organization may be issued by the certificate authority 230.

The blockchain manager service 210 may be configured to launch in one of two modes: a lead mode and a follow mode. Organizations 115 with a blockchain manager service 210 in a lead mode may be a leader organization and organizations with a blockchain manager service 210 in a follow mode may be a follower organization. A leader organization may perform tasks for a follower organization. For example, a leader organization may update a smart contract on behalf of a follower organization. Additionally, the leader organization may be responsible for initializing updates of blockchain configurations. For example, the leader organization may be configured to add a new organization to the consortium, create a new ledger, install a new smart contract, and deploy a new version of a smart contract for a consortium.

At step 1010, the user interface application 345 may be configured to receive a request from an administrator at a follower organization to perform a blockchain activity, such as adding a smart contract 102. For example, the user interface application 345 may receive, from the follower organization, a new smart contract to be added to the blockchain 110 by the leader organization. At step 1020, the user interface application 345 may be configured to retrieve action information from the blockchain manager service 210. For example, the user interface application 345 may make an RPC request or API call to the blockchain manager service 210 within the current organization or at a different organization. The blockchain manager service 210 receiving the RPC request may be configured to provide action information. For example, the blockchain manager service 210 may be configured to provide deployment instructions for the smart contract 102 to perform the ledger or smart contract on behalf of a follower organization.

At step 1030, the blockchain manager service 210 at the leader organization may be configured to retrieve organizational data from the database for the follower organization after receiving a request. Organization data may include information related to the registered organizations such as organization information, ledger inputs, installed smart contracts, and certificate authorities 230. The database may be configured to store and provide information about all registered organizations added to the blockchain 110. The leader blockchain manager service may be configured to retrieve the organizational data via the database adapter 330. At step 1040, the leader blockchain manager service may be configured to respond to the RPC request with the organizational data requested by the user interface application 345.

At step 1050, the user interface application 345 may be configured to request a blockchain action at the follower blockchain manager service. For example, the user interface application 345 may make an RPC request or API call to the follower blockchain manager service. The follower blockchain manager service receiving the RPC request may be configured to prepare and execute a transaction at the blockchain 110. For example, the follower blockchain manager service may be configured to provide transactional data detailing the addition of the smart contract 102 to blockchain 110.

At step 1060, the follower blockchain manager service may be configured to prepare and execute a transaction to the blockchain 110. For example, the follower blockchain manager service may prepare an updated smart contract or a new ledger documenting a new agreement between the organizations on behalf of the follower organization. The follower blockchain manager service may be configured to prepare a transaction to be added to the permissioned distributed ledger to be approved by the other organizations agreeing to the smart contract 102 requested by the follower organization. At step 1070, the follower blockchain manager service may be configured to receive a confirmation of the new smart contract or ledger created at the blockchain 110.

At step 1080, the follower blockchain manager service may be configured to send a confirmation of the blockchain action. For example, the follower blockchain manager service may send a confirmation of the created smart contract at the blockchain 110. At step 1090, the follower blockchain manager service may be configured to notify the administrator that the blockchain action is complete. For example, the controller may output a pop-up window via the user interface application 345 to notify the administrator that the blockchain action is complete. In some embodiments, a leader organization may perform a blockchain activity on behalf of a follower organization.

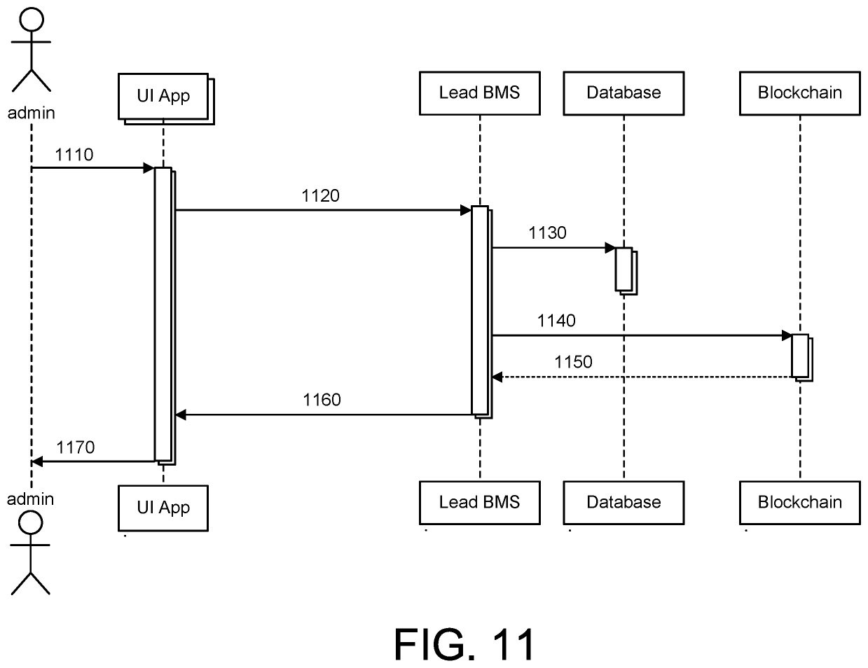

Referring now to FIG. 11, illustrated is a flowchart of an implementation of the blockchain manager service 210 configured to release a new version of a smart contract. A smart contract 102 may be a software program running at each of the peer nodes 120 alongside the blockchain 110. An organization 115 may be a participant of the permissioned distributed ledger and may represent a party to an agreement of a smart contract 102 on the blockchain 110. Together, the group of organizations sharing an authenticating relationship may be a consortium. Each organization may run one or more peer nodes 120. The peer nodes 120 may run smart contracts, accept new transactions, validate new transactions, and store a local copy of ledgers. Together the organizations may form a consortium. In some embodiments, a leader organization may be configured to create and update a blockchain consortium for a follower organization.

At step 1110, the user interface application 345 may be configured to receive a request from an administrator to release a new version of a smart contract 102. For example, the user interface application 345 may receive parameters and a configuration setup for the release a new version of a smart contract 102. The user interface application 345 may be at a leader organization or a follower organization. At step 1120, the user interface application 345 may be configured to pass the request to the leader blockchain manager service. For example, the user interface application 345 may make an RPC request or API call to the leader blockchain manager service within the current organization or at a different organization. The blockchain manager service 210 receiving the RPC request may be configured to release a new version of a smart contract 102 on behalf of a consortium.

At step 1130, the leader blockchain manager service may be configured to retrieve organizational data from the database. Organization data may include information related to the registered organizations such as organization information, ledger inputs, installed smart contracts, and certificate authorities 230. The database may be configured to store and provide information about all registered organizations added to the blockchain 110. The leader blockchain manager service may be configured to retrieve the organizational data via the database adapter 330. The leader blockchain manager service may be configured to provide blockchain SDKs and connection profiles to streamline blockchain development.

At step 1140, the leader blockchain manager service may be configured to prepare and execute a transaction to blockchain to release a new version of the smart contract. For example, the leader blockchain manager service may prepare a transaction for the permissioned blockchain to update the agreement between the organizations 115 of the consortium by releasing a new version of a smart contract 102. The leader blockchain manager service may be configured to prepare a transaction to be added to the permissioned blockchain to be approved by the other organizations agreeing to the new version of a smart contract 102. At step 1150, the leader blockchain manager service may be configured to receive a confirmation of the release the new version of the smart contract 102 at the blockchain 110.

At step 1160, the leader blockchain manager service may be configured to send a confirmation of the release of the new version of the smart contract 102. For example, the leader blockchain manager service may be configured to send a confirmation to a follower organization of the updated smart contract at the blockchain 110. At step 1170, the user interface application 345 may be configured to notify the administrator that the release of the new version of the smart contract 102 is complete. For example, the controller may output a pop-up window via the user interface application 345 to notify the administrator that the release of the new version of the smart contract 102 is complete. In some embodiments, a leader organization may be configured to release the new version of the smart contract 102 on behalf of a follower organization.

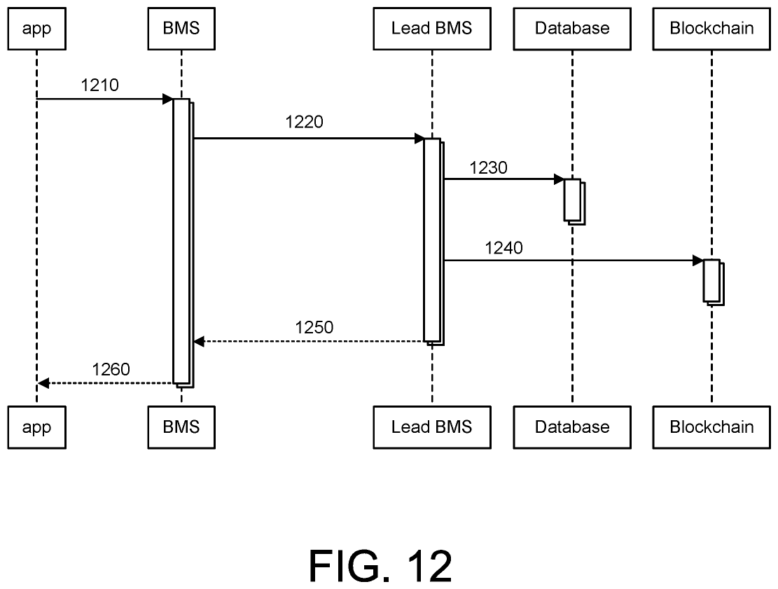

Referring now to FIG. 12, illustrated is a flowchart of an implementation of the blockchain manager service 210 obtaining a connection profile. A connection profile may include a set of key-value pairs required to establish a connection with the blockchain 110, such as a peer address or a smart contract name. A connection profile may also include information related to an organization's connectivity to the blockchain 110.

At step 1210, the user interface application 345 may be configured to receive a request from an administrator to obtain a connection profile. For example, the user interface application 345 may receive instructions and configuration data to obtain a connection profile. The user interface application 345 may be configured to obtain the connection profile from a blockchain manager service 210 at a follower organization. For example, the user interface application 345 may make an RPC request or API call to the follower blockchain manager service within the current organization or at a different organization to obtain key-value pairs required to make a connection to the blockchain 110. The follower blockchain manager service receiving the RPC request may be configured to obtain the connection profile from a leader blockchain manager service.

At step 1220, the follower blockchain manager service may make a request to obtain the connection profile from a leader blockchain manager service. For example, the follower blockchain manager service may make an RPC request or API call to the leader blockchain manager service within the current organization or at a different organization to obtain key-value pairs required to make a connection to the blockchain 110. At step 1230, the leader blockchain manager service may be configured to retrieve key-value pairs and other organizational data from the database. Organization data includes information related to the registered organizations such as organization information, ledger inputs, installed smart contracts, and certificate authorities 230. The database may store and provide information about all registered organizations added to the blockchain 110. The leader blockchain manager service may retrieve the key-value pair and other organizational data via the database adapter 330. The leader blockchain manager service may be configured to provide blockchain SDKs and connection profiles to streamline blockchain development.

At step 1240, the leader blockchain manager service may be configured to obtain transactional data from the blockchain 110 to determine a connection profile on behalf of the follower organization. For example, the leader blockchain manager service may be configured to obtain a peer address from the blockchain 110 for an application of the follower organization. In another example, the leader blockchain manager service may establish a connection with the blockchain 110 on behalf of the follower blockchain manager.

At step 1250, the leader blockchain manager service may be configured to send the obtained connection profile to the follower blockchain management system. For example, the blockchain manager service 210 may be configured to send the key-value pair to the follower blockchain management system. At step 1260, the blockchain manager service 210 may be configured to respond to the RPC call by providing the obtained connection profile. For example, the follower blockchain management system may output a response to an API call to provide the connection profile to the administrator at the user interface application 345. In some embodiments, the leader organization may be configured to obtain the connection profile for an application of the follower organization.

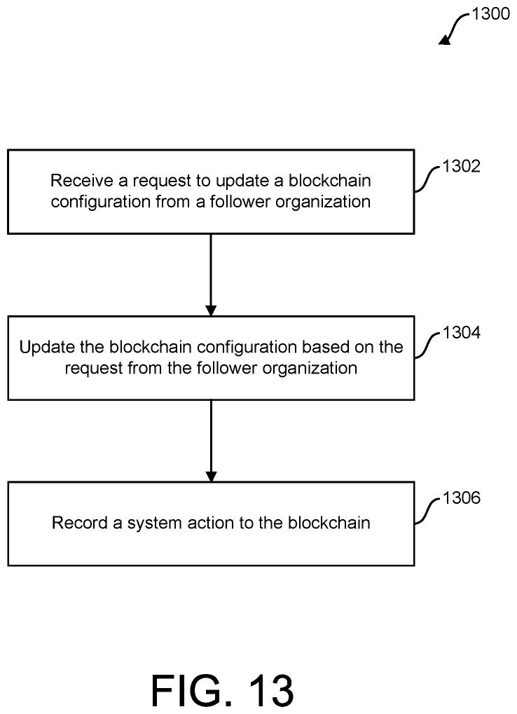

Referring now to FIG. 13, illustrated is a flowchart illustrating an example of an updating process 1300 for a blockchain manager system 205. In some example embodiments, a blockchain manager system 205 may be configured to interact with organizations or entities having a blockchain manager service 210 to perform various permissioned tasks. For example, a blockchain manager system 205 may deploy a new version of a smart contract 102 on behalf of a follower organization. In some example embodiments, a blockchain deployment tool 220 may be configured to deploy private blockchains and permissioned distributed ledgers between authenticating entities. For example, the blockchain deployment tool 220 may be configured to add peer nodes 120 with zero downtime.

At 1302, a leader organization may receive a request to update a blockchain configuration from a follower organization. The leader organization may be configured to update the blockchain configuration based on the request from the follower organization. For example, the leader organization may receive a request to update a ledger configuration on behalf of a follower organization. In another example, the leader organization may receive a request to update a smart contract 102 on behalf of a follower organization. The leader organization and the follower organization may be included in the blockchain consortium.

At 1304, the leader organization may update the blockchain configuration based on the request from the follower organization. For example, the leader organization may update a ledger configuration on behalf of a follower organization. In another example, the leader organization may update a smart contract 102 on behalf of a follower organization. Additionally, the leader organization may be configured to send a confirmation of the registration of the new organization to the follower organization. Additionally, the leader organization may be configured to send a confirmation of the updated smart contract to the follower organization.

At 1306, the leader organization may be configured to record a system action to the blockchain 110. The system action may be representative of the updated blockchain configuration. For example, the leader organization may record a new transaction to the permissioned distributed ledger detailing that a ledger configuration was updated on behalf of a follower organization. In another example, the leader organization may record a new transaction to the permissioned distributed ledger detailing that a smart contract was updated on behalf of a follower organization.

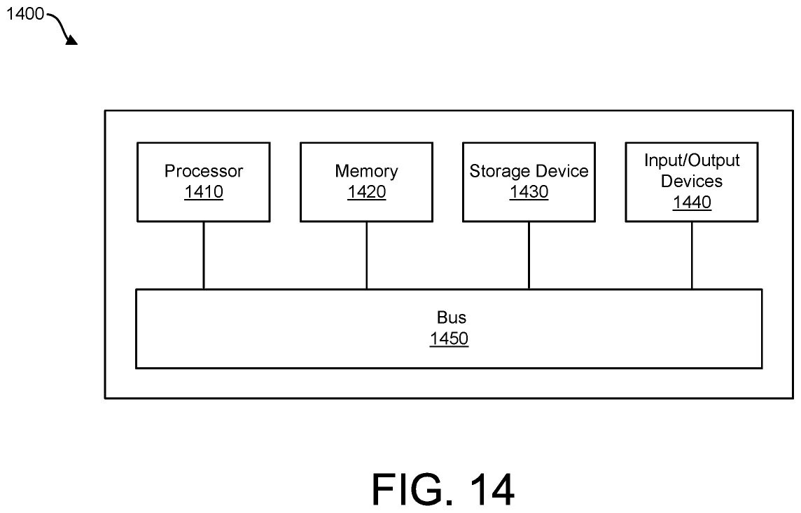

Referring now to FIG. 14, illustrated is a block diagram illustrating an example of a computing system 1400 consistent with implementations of the current subject matter. Referring to FIGS. 1-14, the computing system 1400 may be used to implement the blockchain manager system and/or any component therein. For example, the computing system 1400 may implement user equipment, a personal computer, or a mobile device.

As shown in FIG. 14, the computing system 1400 may include a processor 1410, a memory 1420, a storage device 1430, and an input/output device 1440. The processor 1410, the memory 1420, the storage device 1430, and the input/output device 1440 may be interconnected via a system bus. The processor 1410 is capable of processing instructions for execution within the computing system 1400. Such executed instructions may implement one or more components of, for example, the blockchain manager system. In some example embodiments, the processor 1410 may be a single-threaded processor. Alternately, the processor 1410 may be a multi-threaded processor. The processor 1410 is capable of processing instructions stored in the memory 1420 and/or on the storage device 1430 to display graphical information for a user interface provided via the input/output device 1440.

The memory 1420 is a non-transitory computer-readable medium that stores information within the computing system 1400. The memory 1420 may store data structures representing configuration object databases, for example. The storage device 1430 is capable of providing persistent storage for the computing system 1400. The storage device 1430 may be a floppy disk device, a hard disk device, an optical disk device, or a tape device, or other suitable persistent storage means. The input/output device 1440 provides input/output operations for the computing system 1400. In some example embodiments, the input/output device 1440 includes a keyboard and/or pointing device. In various implementations, the input/output device 1440 includes a display unit for displaying graphical user interfaces.

According to some example embodiments, the input/output device 1440 may provide input/output operations for a network device. For example, the input/output device 1440 may include Ethernet ports or other networking ports to communicate with one or more wired and/or wireless networks (e.g., a local area network (LAN), a wide area network (WAN), the Internet, a public land mobile network (PLMN), and/or the like).

In some example embodiments, the computing system 1400 may be used to execute various interactive computer software applications that may be used for organization, analysis and/or storage of data in various formats. Alternatively, the computing system 1400 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 1440. The user interface may be generated and presented to a user by the computing system 1400 (e.g., on a computer screen monitor, etc.).

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

In the detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

What is claimed is:

1. A method for updating a blockchain shared by a blockchain consortium, the method comprising:
receiving, from a follower organization and by one or more processors at a leader organization, a request to update a blockchain configuration, the leader organization being configured to update the blockchain configuration based on the request from the follower organization, the leader organization and the follower organization included in the blockchain consortium;
updating, by the one or more processors, the blockchain configuration based on the request from the follower organization; and
recording, by the one or more processors, a system action to the blockchain, the system action representative of the updated blockchain configuration.

2. The method of claim 1, wherein updating the blockchain configuration includes at least one of adding an organization to the blockchain consortium, managing a smart contract, and deploying a new smart contract.

3. The method of claim 1, wherein the follower organization includes a blockchain management service configured to send the request to the leader organization for updating the block configuration and wherein the request from the follower organization is received through an API call at the leader organization.

4. The method of claim 1, further comprising:
requesting, by the one or more processors, approval of the request to update the blockchain configuration from an additional organization in the blockchain consortium;
receiving, by the one or more processors, the approval to update the blockchain configuration from the additional organization of the blockchain consortium; and
updating, in response to receiving the approval to update the blockchain configuration from the additional organization and by the one or more processors, the blockchain configuration based on the request from the follower organization.

5. The method of claim 1, further comprising:
sending, by the one or more processors, a response to the follower organization based on data obtained from a database, the data configured to enable the follower organization to record the system action to the blockchain based on the updated blockchain configuration.

6. The method of claim 1, further comprising:
notifying, by the one or more processors, the follower organization of the updated blockchain configuration; and
instructing, by the one or more processors, the follower organization to record the system action to the blockchain, the system action representative of the updated blockchain configuration.

7. The method of claim 1, wherein the leader organization is configured to perform at least one of adding an organization to the blockchain consortium, manage a smart contract, and validate the request to update the blockchain configuration from the blockchain consortium.

8. The method of claim 1, wherein the request to update the blockchain includes deploying a new smart contract and wherein the leader organization is configured to deploy the new smart contract based on the request from the follower organization.

9. The method of claim 1, wherein the request to update the blockchain includes adding an organization to the blockchain consortium and wherein the leader organization is configured to obtain organization data from a database of the organization and records an act of adding the organization to the blockchain based on the request from the follower organization.

10. The method of claim 1, wherein the request to update the blockchain configuration includes utilizing a blockchain manager service, the blockchain manager service including at least one of a monitoring service, a database adapter, and a secure storage adapter.

11. A system for updating a blockchain shared by a blockchain consortium, the system comprising:
at least one processor, and
at least one non-transitory storage media storing instructions that, when executed by the at least one processor, cause the at least one processor to perform operations comprising:
receive, from a follower organization and at a leader organization, a request to update a blockchain configuration, the leader organization being configured to update the blockchain configuration based on the request from the follower organization, the leader organization and the follower organization included in the blockchain consortium;
update the blockchain configuration based on the request from the follower organization; and
record a system action to the blockchain, the system action representative of the updated blockchain configuration.

12. The system of claim 11, wherein updating the blockchain configuration includes at least one of adding an organization to the blockchain consortium, managing a smart contract, and deploying a new smart contract.

13. The system of claim 11, wherein the follower organization includes a blockchain management service configured to send the request to the leader organization for updating the block configuration and wherein the request from the follower organization is received through an API call at the leader organization.

14. The system of claim 11, further comprising:
requesting approval of the request to update the blockchain configuration from an additional organization in the blockchain consortium;
receiving the approval to update the blockchain configuration from the additional organization of the blockchain consortium; and
updating, in response to receiving the approval to update the blockchain configuration from the additional organization, the blockchain configuration based on the request from the follower organization.

15. The system of claim 11, further comprising:
sending a response to the follower organization based on data obtained from a database, the data configured to enable the follower organization to record the system action to the blockchain based on the updated blockchain configuration.

16. The system of claim 11, further comprising:
notifying the follower organization of the updated blockchain configuration; and
instructing the follower organization to record the system action to the blockchain, the system action representative of the updated blockchain configuration.

17. The system of claim 11, wherein the leader organization is configured to perform at least one of adding an organization to the blockchain consortium, manage a smart contract, and validate the request to update the blockchain configuration from the blockchain consortium.

18. The system of claim 11, wherein the request to update the blockchain includes deploying a new smart contract and wherein the leader organization is configured to deploy the new smart contract based on the request from the follower organization.

19. The system of claim 11, wherein the request to update the blockchain includes adding an organization to the blockchain consortium and wherein the leader organization is configured to obtain organization data from a database of the organization and records an act of adding the organization to the blockchain based on the request from the follower organization.

20. A non-transitory computer-readable storage medium for updating a blockchain shared by a blockchain consortium comprising at least one program for execution by one or more processors of a first device, the at least one program including instructions which, when executed by the one or more processors, cause the first device to perform:
receiving, from a follower organization and by the one or more processors at a leader organization, a request to update a blockchain configuration, the leader organization being configured to update the blockchain configuration based on the request from the follower organization, the leader organization and the follower organization included in the blockchain consortium;
updating, by the one or more processors, the blockchain configuration based on the request from the follower organization; and
recording, by the one or more processors, a system action to the blockchain, the system action representative of the updated blockchain configuration.
